(19) United States
(12) Patent Application Publication
(10) Pub. No.: US 2026/0230382 A1
(43) Pub. Date: Aug. 6, 2026

(54) NETWORK CONFIGURATION USING HIERARCHICAL MULTI-AGENT REINFORCEMENT LEARNING

(71) Applicant: Telefonaktiebolaget LM Ericsson (publ), Stockholm (SE)

(72) Inventors: Maxime BOUTON, Stockholm (SE); Jaeseong JEONG, Solna (SE); Leif WILHELMSSON, Lund (SE); Alessandro PREVITI, Stockholm (SE); Hossein SHOKRI GHADIKOLAEI, Täby (SE)

(21) Appl. No.: 19/149,735

(22) PCT Filed: Jan. 31, 2023
(86) PCT No.: PCT/EP2023/052340

§ 371 Date: Jul. 21, 2025

(51) Int. Cl. H04L 41/0823; H04L 41/12

(52) U.S. Cl. CPC H04L 41/0823; H04L 41/12

(57) ABSTRACT

A method, system and apparatus are disclosed. A first network node configured to communicate with a plurality of network nodes is described. Each network node of the plurality of network nodes is configurable to communicate with one or more wireless devices in a network. The first network node includes processing circuitry configured to determine a network configuration of one or more network nodes of the plurality of network nodes using one or both of a coordination layer and a hierarchical layer and cause transmission of the network configuration to the one or more network nodes to configure the one or more network nodes to communicate with the one or more wireless devices using the network configuration.

### TECHNICAL FIELD

The present disclosure relates to wireless communications, and in particular, to the configuration of network nodes and/or network devices such as access points.

### BACKGROUND

The Institute of Electrical and Electronics Engineers (IEEE) promulgates one or more standards associated with communication between network nodes (e.g., access points (APs)) and wireless devices (WDs) (e.g., stations (STAs)) in a network. Such communication may use wireless communication protocols such as based on the IEEE 802.11 family of standards (e.g., Wi-Fi).

In a typical network based on the IEEE 802.11 family of standards, the number of WDs connected to the network and, more specifically, to the different network nodes (e.g., APs) may vary. In addition, data rate requirements for both uplink and downlink for different active WDs can vary as well, e.g., from 10 Mb/s to tens of Gb/s. In some cases where variations of the number of WDs connected and/or the data rate requirements vary, static allocation of resources to the different APs produces undesired results as some network nodes (e.g., APs) may underutilize or overutilize some of the resources.

Conventional solutions do not adapt to the variations (e.g., in the environment) or require the use of limiting modeling assumptions in case adaptation is performed. Furthermore, automation capabilities of conventional solutions are typically hand-engineered, which produce suboptimal results in some network deployments and are typically not scalable.

### SUMMARY

Some embodiments advantageously provide methods, systems, and apparatuses for configuration of network nodes such as access points. Network planning may comprise estimating coverage and capacity needs, taking into account variation in traffic, and determining what configuration to apply to each network node (e.g., APs) to be deployed. In some embodiments, network nodes (APs) may be deployed in order to maximize some specific measure, such as a maximum aggregated throughput that can be supported or a maximum number of users that can be supported, where each user may demand a certain data rate. An approach in network planning may comprise frequency planning, e.g., dividing the total available bandwidth among the network nodes with a certain frequency reuse. A reuse factor may be selected to ensure that co-channel interference does not impact the performance in a cell. However, the complexity of allocating bandwidth to network nodes (e.g., AP), and dynamically turning network nodes on and off may increase with the size of the networks. Some networks use wide channels and support load balancing protocols.

Conventional reinforcement learning (RL) algorithms for network configuration have been proposed but do not address the problem of bandwidth selection or AP selectively being switched off. In addition, conventional algorithms do not provide any coordination across APs.

In some embodiments, bandwidth and channel selection and/or network node on/off switching is described, which may be performed at a higher decision making level (when compared with conventional systems) and with a learnable coordinated policy. In some other embodiments, better performance than in conventional systems may be obtained when only a subset of network nodes (e.g., APs) are active for certain positions and requirements of the active STAs. In an embodiment, artificial intelligence (AI) (e.g., rather than just analytics) may be used for automated network management.

According to one aspect, a first network node configured to communicate with a plurality of network nodes is described. Each network node of the plurality of network nodes is configurable to communicate with one or more wireless devices in a network. The first network node comprises processing circuitry configured to determine a network configuration of one or more network nodes of the plurality of network nodes using one or both of a coordination layer and a hierarchical layer and cause transmission of the network configuration to the one or more network nodes to configure the one or more network nodes to communicate with the one or more wireless devices using the network configuration.

In some embodiments, the processing circuitry is further configured to determine one or more key performance indicators (KPIs) associated with the plurality of network nodes to determine the network configuration.

In some other embodiments, the processing circuitry is further configured to collect data from the network by measuring the one or more KPIs and obtaining information about a network topology of the network.

In some embodiments, the collection of data from the network comprises one or both of: measuring a path loss between each network node of the plurality of network nodes; and determining relations between each network node based at least in part on the path loss, the determined relations being represented as a graph.

In some other embodiments, the processing circuitry is further configured to feed the collected data into a learning agent comprising the coordination layer.

In some embodiments, the processing circuitry is further configured to determine one or more embeddings associated with the one or more network nodes based on the collected data that is fed to the learning agent, the collected data comprising one or both of network node individual features and a graph topology with edge features.

In some other embodiments, the processing circuitry is further configured to determine one or both of a band parameter and a channel parameter associated with the one or more network nodes using a band selection policy and a channel selection policy of the hierarchical layer based on the one or more embeddings. The one or both of the band parameter and the channel parameter are comprised in the network configuration.

In some embodiments, the processing circuitry is further configured to one or both of collect a reward from the network and update the learning agent based on the collected reward.

In some other embodiments, the processing circuitry is further configured to cause transfer of the learning agent to another network node in another network.

In some embodiments, one or more of: the plurality of network nodes comprises a second network node and a third network node; the first network node is one or both of a network configuration node and a first access point; the second network node is a second access point; the third network node is a third access point; the network is configurable with communication protocol based on an Institute of Electrical and Electronics Engineers (IEEE) 802.11 standard; and the configuration is determined using hierarchical multi-agent reinforcement learning.

According to another aspect, a method in a first network node configured to communicate with a plurality of network nodes is described. Each network node of the plurality of network nodes is configurable to communicate with one or more wireless devices in a network. The method comprises determining a network configuration of one or more network nodes of the plurality of network nodes using one or both of a coordination layer and a hierarchical layer; and transmitting the network configuration to the one or more network nodes to configure the one or more network nodes to communicate with the one or more wireless devices using the network configuration.

In some embodiments, the method further comprises determining one or more key performance indicators (KPIs) associated with the plurality of network nodes to determine the network configuration.

In some other embodiments, the method further comprises collecting data from the network by measuring the one or more KPIs and obtaining information about a network topology of the network.

In some embodiments, the collection of data from the network comprises one or both of measuring a path loss between each network node of the plurality of network nodes; and determining relations between each network node based at least in part on the path loss, where the determined relations are represented as a graph.

In some other embodiments, the method further comprises feeding the collected data into a learning agent comprising the coordination layer.

In some embodiments, the method further comprises determining one or more embeddings associated with the one or more network nodes based on the collected data that is fed to the learning agent. The collected data comprises one or both of network node individual features and a graph topology with edge features.

In some other embodiments, the method further comprises determining one or both of a band parameter and a channel parameter associated with the one or more network nodes using a band selection policy and a channel selection policy of the hierarchical layer based on the one or more embeddings. The one or both of the band parameter and the channel parameter are comprised in the network configuration.

In some embodiments, the method further comprises one or both of collecting a reward from the network and updating the learning agent based on the collected reward.

In some other embodiments, the method further comprises transferring the learning agent to another network node in another network.

In some embodiments, one or more of the plurality of network nodes comprises a second network node and a third network node; the first network node is one or both of a network configuration node and a first access point; the second network node is a second access point; the third network node is a third access point; the network is configurable with communication protocol based on an Institute of Electrical and Electronics Engineers (IEEE) 802.11 standard; and the configuration is determined using hierarchical multi-agent reinforcement learning.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating exemplary methods implemented in a communication system including a host computer, a network node and a wireless device for executing a client application at a wireless device according to some embodiments of the present disclosure;

FIG. 4 is a flowchart illustrating exemplary methods implemented in a communication system including a host computer, a network node and a wireless device for receiving user data at a wireless device according to some embodiments of the present disclosure;

FIG. 5 is a flowchart illustrating exemplary methods implemented in a communication system including a host computer, a network node and a wireless device for receiving user data from the wireless device at a host computer according to some embodiments of the present disclosure;

FIG. 6 is a flowchart illustrating exemplary methods implemented in a communication system including a host computer, a network node and a wireless device for receiving user data at a host computer according to some embodiments of the present disclosure;

FIG. 7 is a flowchart of an exemplary process in a network node according to some embodiments of the present disclosure;

FIG. 8 shows an example network scenario where dynamically updating a network configuration in a coordinated fashion may be used according to some embodiments of the present disclosure;

FIG. 9 shows another example network scenario where dynamically updating a network configuration in a coordinated fashion may be used according to some embodiments of the present disclosure;

FIG. 10 shows yet another example network scenario where dynamically updating a network configuration in a coordinated fashion may be used according to some embodiments of the present disclosure;

FIG. 11 shows an example process and/or corresponding components according to some embodiments of the present disclosure;

FIG. 12 shows an example coordination layer (e.g., of a learning agent) according to some embodiments of the present disclosure;

FIG. 13 shows an example hierarchical layer (e.g., hierarchical reinforcement learning model) according to some embodiments of the present disclosure; and

FIG. 14 shows an example network node (e.g., network configuration node, network optimization node) configured to train a learning agent according to some embodiments of the present disclosure.

### DETAILED DESCRIPTION

Before describing in detail exemplary embodiments, it is noted that the embodiments reside primarily in combinations of apparatus components and processing steps related to configuration of network nodes such as access points. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some other embodiments, the term “network” may refer to one or more communication networks such as radio networks, wireless/wired networks, access networks, intermediate networks, core networks, or any other networks associated with one or more communication protocols such as Wi-Fi.

Further, the term “network node” used herein can be any kind of network node comprised in a radio network which may further comprise any of an access point (AP) (e.g., an access point associated with any protocol such as a Wi-Fi AP, a radio AP, etc.). In some embodiments, the network node may comprise a network node implemented using standards such as the Third Generation Partnership Project (3GPP).

Th 3GPP has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

In some embodiments, the network node may comprise a base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment, a network device, a server, a computer (e.g., such as a personal computer), etc. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, IEEE 802.11, 3GPP LTE and/or New Radio (NR), may be used in this disclosure, this should not be seen as limiting the scope of the disclosure to only the aforementioned system. Other wireless systems may also benefit from exploiting the ideas covered within this disclosure.

In some embodiments, the term embedding is used and may refer to a representation (e.g., a mathematical representation) of data, which may comprise one or more vectors (e.g., a relatively low dimensional vector).

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices. Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

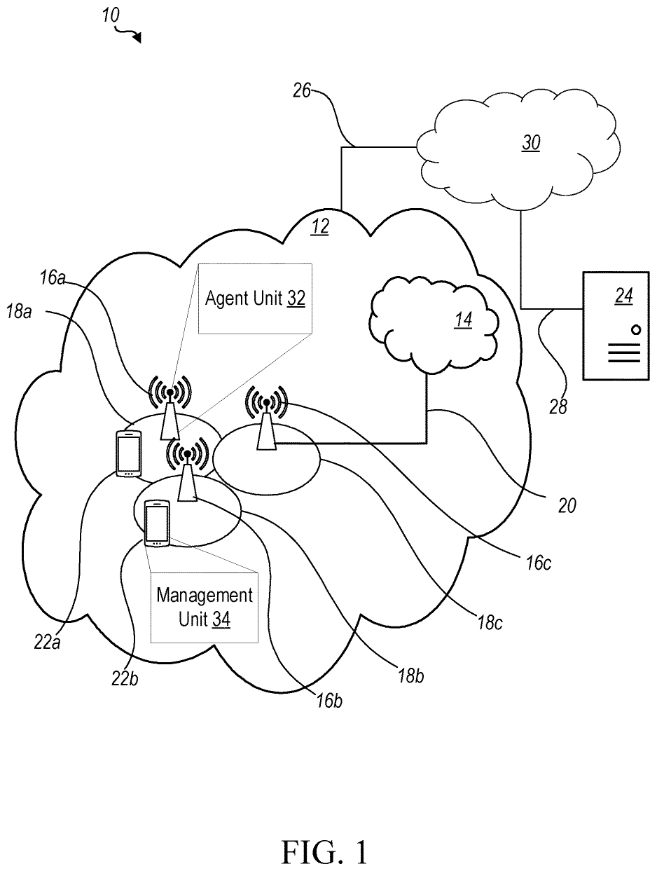

Referring now to the drawing figures, in which like elements are referred to by like reference numerals, there is shown in FIG. 1 a schematic diagram of a communication system 10, according to an embodiment, such as a Wi-Fi network, which comprises an access network 12, such as a radio access network, and a core network 14. The access network 12 comprises a plurality of network nodes 16a, 16b, 16c (referred to collectively as network nodes 16), such as access points (APs) or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16. In some embodiments, the system 10 may be associated with another network such as a 3GPP-type cellular network that may support standards such as LTE and/or NR (5G). In some other embodiments, network nodes 16 may comprise NBs, eNBs, gNBs.

Also, it is contemplated that a WD 22 can be in simultaneous communication and/or configured to separately communicate with more than one network node 16 and more than one type of network node 16. For example, a WD 22 can have dual connectivity with a network node 16 that supports Wi-Fi (e.g., a first Wi-Fi protocol, a first radio access technology such as LTE) and the same or a different network node 16 that supports another protocol (e.g., a second Wi-Fi protocol, a second radio access technology such as NR).

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include agent unit 32 which is configured to perform any step and/or task and/or process and/or method and/or feature described in the present disclosure. In a nonlimiting example, agent unit 32 may be configured to determine a network configuration of one or more network nodes 16 of a plurality of network nodes 16 using one or both of a coordination layer and a hierarchical layer; and/or cause transmission of the network configuration to the one or more network nodes 16 to configure the one or more network nodes 16 to communicate with the one or more wireless devices 22 using the network configuration. In another nonlimiting example, agent unit 32 may be configured to perform one or more actions associated with a learning agent and/or comprise the learning agent. In yet another nonlimiting example, agent unit 32 may be configure to perform coordination layer functions, encoder functions, message passing of graph neural network, decoder functions, hierarchical model (base selection policy, channel selection policy) functions, reward functions, determine/receive/transmit training data, agent update functions, hierarchical action selection functions, multi-agent reinforcement learning (MARL) coordination functions, reward determinations, collection of network data, determination/transmission of a shared model, training data storage functions, etc.

A wireless device 22 is configured to include a management unit 34 which is configured to perform any step and/or task and/or process and/or method and/or feature described in the present disclosure, e.g., process associated with communication with APs, or any other process such as described with respect to agent unit 32.

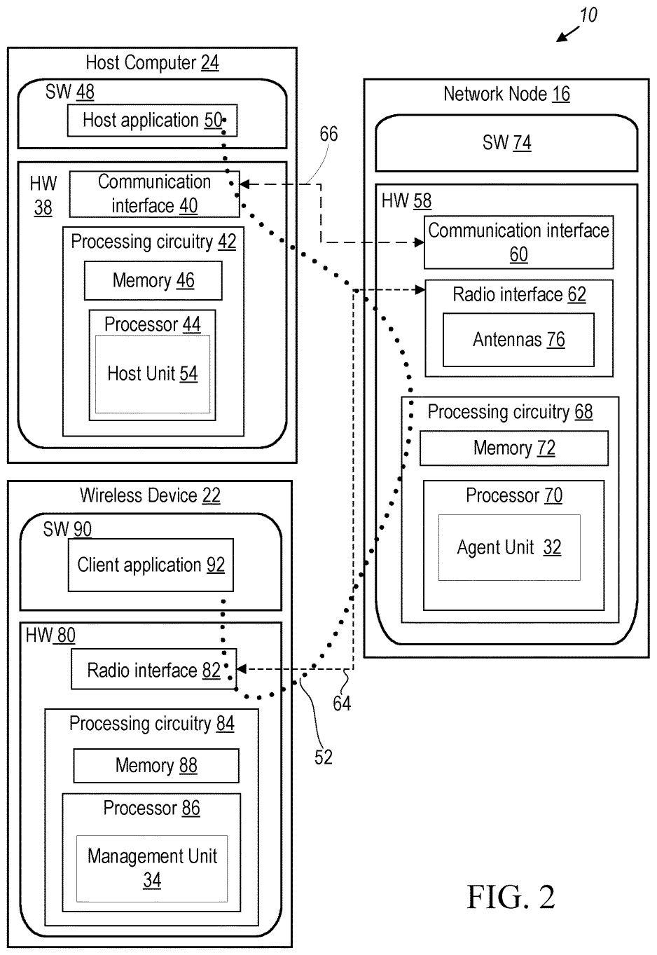

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host unit 54 configured to enable the service provider to perform any step and/or task and/or process and/or method and/or feature described in the present disclosure, e.g., observe/monitor/control/transmit to/receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include agent unit 32 configured to perform any step and/or task and/or process and/or method and/or feature described in the present disclosure, e.g., as related to network node 16.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a management unit 34 configured to perform any step and/or task and/or process and/or method and/or feature described in the present disclosure, e.g., as related to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes;

the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as agent unit 32, and management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

FIG. 3 is a flowchart illustrating an exemplary method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

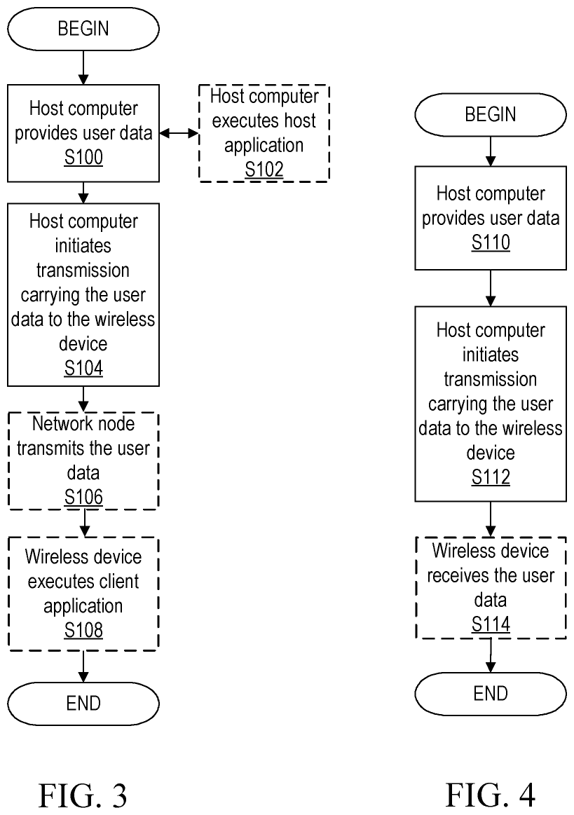

FIG. 4 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

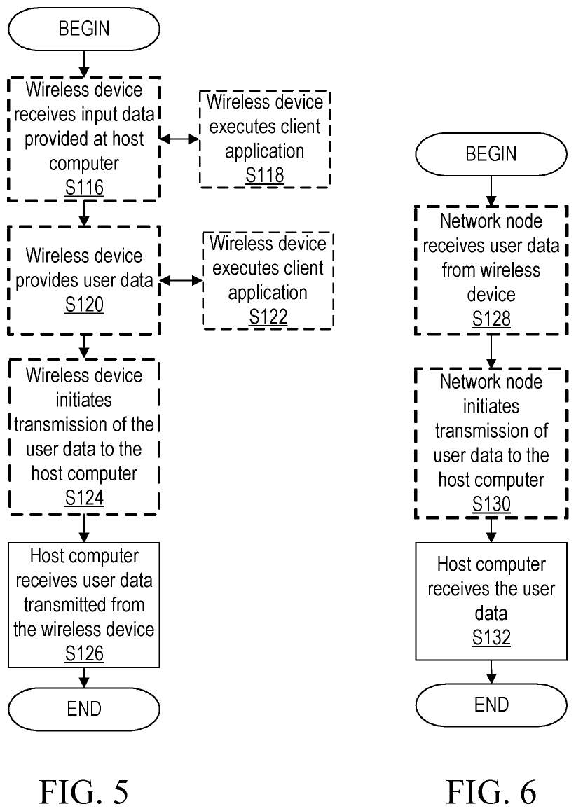

FIG. 5 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

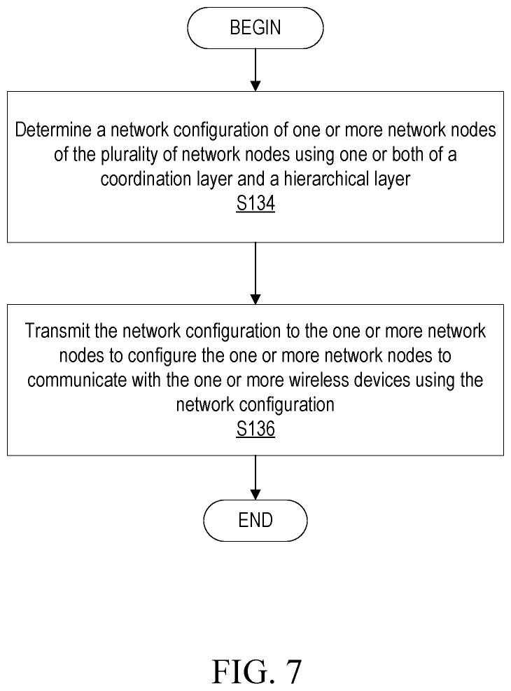

FIG. 7 is a flowchart of an exemplary process (i.e., method) in a network node 16 (e.g., network node 16a). One or more blocks described herein may be performed by one or more elements of network node 16 such as by one or more of processing circuitry 68 (including the agent unit 32), processor 70, radio interface 62 and/or communication interface 60. Network node 16 such as via processing circuitry 68 and/or processor 70 and/or radio interface 62 and/or communication interface 60 is configured to determine (Block S134) a network configuration of one or more network nodes of the plurality of network nodes using one or both of a coordination layer and a hierarchical layer; and transmit (Block S136) the network configuration to the one or more network nodes to configure the one or more network nodes to communicate with the one or more wireless devices using the network configuration.

In some embodiments, the method further comprises determining one or more key performance indicators (KPIs) associated with the plurality of network nodes 16 to determine the network configuration.

In some other embodiments, the method further comprises collecting data from the network by measuring the one or more KPIs and obtaining information about a network topology of the network 12, 14.

In some embodiments, the collection of data from the network 12, 14 comprises one or both of measuring a path loss between each network node 16 of the plurality of network nodes 16; and determining relations between each network node 16 based at least in part on the path loss, where the determined relations are represented as a graph.

In some other embodiments, the method further comprises feeding the collected data into a learning agent comprising the coordination layer.

In some embodiments, the method further comprises determining one or more embeddings associated with the one or more network nodes 16 based on the collected data that is fed to the learning agent. The collected data comprises one or both of network node individual features and a graph topology with edge features.

In some other embodiments, the method further comprises determining one or both of a band parameter and a channel parameter associated with the one or more network nodes 16 using a band selection policy and a channel selection policy of the hierarchical layer based on the one or more embeddings. The one or both of the band parameter and the channel parameter are comprised in the network configuration.

In some embodiments, the method further comprises one or both of collecting a reward from the network 12, 14 and updating the learning agent based on the collected reward.

In some other embodiments, the method further comprises transferring the learning agent to another network node 16 in another network 12, 14.

In some embodiments, one or more of the plurality of network nodes 16 comprises a second network node 16b and a third network node 16c; the first network node 16a is one or both of a network configuration node and a first access point; the second network node 16b is a second access point; the third network node 16c is a third access point; the network 12, 14 is configurable with communication protocol based on an Institute of Electrical and Electronics Engineers (IEEE) 802.11 standard; and the configuration is determined using hierarchical multi-agent reinforcement learning.

Having described the general process flow of arrangements of the disclosure and having provided examples of hardware and software arrangements for implementing the processes and functions of the disclosure, the sections below provide details and examples of arrangements for configuration of network nodes 16 such as access points

In some embodiments, a reinforcement learning process (e.g., algorithm) is described. In some other embodiments, the reinforcement learning process is used to dynamically control a network (e.g., a Wi-Fi network) in a coordinated way. In an embodiment, the coordination does not necessarily need a central orchestrator and all processes can be done in a distributed fashion. In another embodiment, the process learns from data to configure the network (e.g., such as optimally, under some optimization criterion). The learning and/or configuration may be used to provide a quality of service that exceeds a quality threshold while minimizing the use of resources. In some embodiments, the process relies on a hierarchical control mechanism to decide whether to turn off (or on) the network node 16 (e.g., AP) or how to use a band and/or a channel.

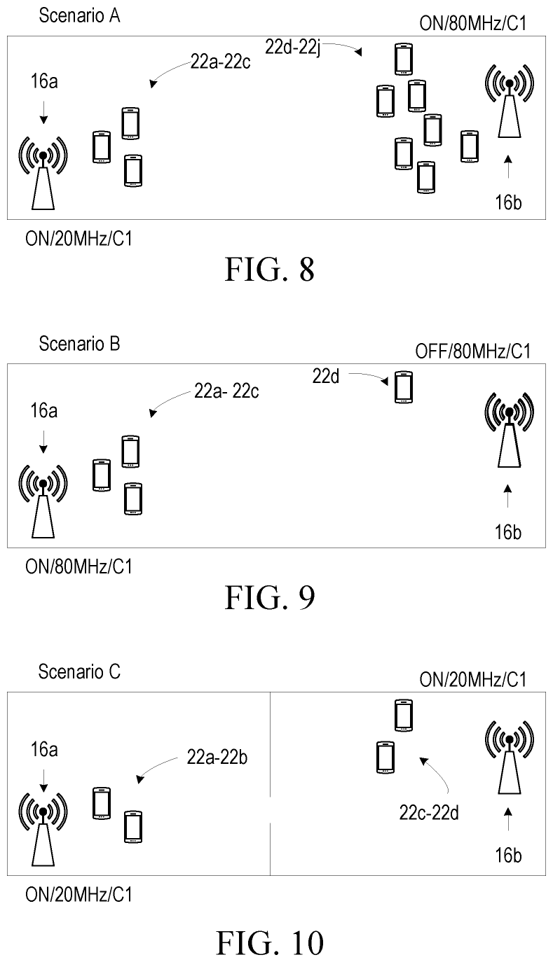

Once trained, network node 16 (e.g., agent unit 32 such as an agent) may be configured to address one or more scenarios. Example scenarios are shown in FIGS. 8-10, i.e., where dynamically updating a network configuration in a coordinated fashion may be used.

Scenario A (shown in FIG. 8): In cases where demand in a part of the network (e.g., WDs 22d-22j served by network node 16b) exceeds the demand of other parts of the network (e.g., WDs 22a-22c served by network node 16a), the available bandwidth (e.g., associated with network node 16b) can be dynamically adjusted to reflect the needs in the part of the network.

Scenario B (shown in FIG. 9): In cases where network traffic is less than a predetermined threshold, network node 16b (e.g., AP, serving WD 22d) can be turned off, while network node 16a (e.g., serving WDs 22a-22c) can be configured to use a wider band to maintain quality of service (QoS). Turning network node 16b off and/or reconfiguring network node 16a may result in a reduction of energy consumption.

Scenario C (shown in FIG. 10): Depending on the environment and the topology, the process may comprise determining to keep the two network nodes 16 (e.g., APs) on. In some embodiments, network nodes 16 may be configured to use bands within a predetermined threshold and/or non-overlapping bands.

In some other embodiments, network node 16 (e.g., via agent unit 32 such as a learning agent) may be configured to automatically learn one or more types of intelligent configuration strategies from incoming data from the network and/or information about the network topology.

In an embodiment, an initial training may be performed using a simulator, where an accurate model of the network (such as a digital twin) is used. In another embodiment, the model deployed on an operational network can be initiated with a starting point that is obtained after training on the digital twin.

In some embodiments, one or more determinations may be performed: (A) how to coordinate each network node 16 (access points) in an efficient way; and (B) how to handle all the possible decisions such as many possible bandwidths and channels. To address (A), a coordination layer may be determined based on graph neural networks. Further, (B) may be addressed by determining a hierarchical action space in one or more levels (e.g., two levels. The first (i.e., higher) level may be used to determine whether to change bandwidth incrementally (and/or include the possibility to turn off a network node 16 (e.g., AP)). The second level may rely on action masking to select the channel based on the determination of the first level. A hierarchical policy (or policy structure) may be used.

In some embodiments, a process such as a multi-agent reinforcement learning (RL) process to optimize a one or more networks (e.g., access network 12 such as a Wi-Fi network). Any component of system 10 may be configured to perform the process such as network node 16, WD 22, host computer 24, etc. In some other embodiments, the process comprises one or both a coordination layer and a hierarchical RL layer. In an embodiment, data is collected from the network (e.g., the network being configured, the network being optimized). In an embodiment, data collection can be shared across multiple networks (e.g., access networks 12a, 12b, 12c, 12d, core network 14, intermediate network 30, any other network). In another embodiment, network node 16 (e.g., via agent unit 32) performs signaling to/from other network nodes 16 (e.g., APs) to enable intelligence throughout the network. In some embodiments, network node 16 (e.g., agent unit 32) may be an AP.

In one or more embodiments, bandwidth control using a multi-agent RL comprises automatically learning coordination behaviors. In some embodiments, an action space is modeled as hierarchical, e.g., where hierarchy is given to one or more parameters such as bandwidth, power, and channel. In some other embodiments, energy saving can be achieved by dynamically turning network nodes 16 (e.g., APs) off. In an embodiment, QoS of connected users may be better than QoS of conventional configurations due to dynamic allocation of bandwidth and power to the serving network nodes 16 (e.g., AP). In some embodiments, configuration of the network is efficient intelligence (e.g., in terms of sampling and computational complexity) compared to traditional flat intelligence processes, such as conventional RL.

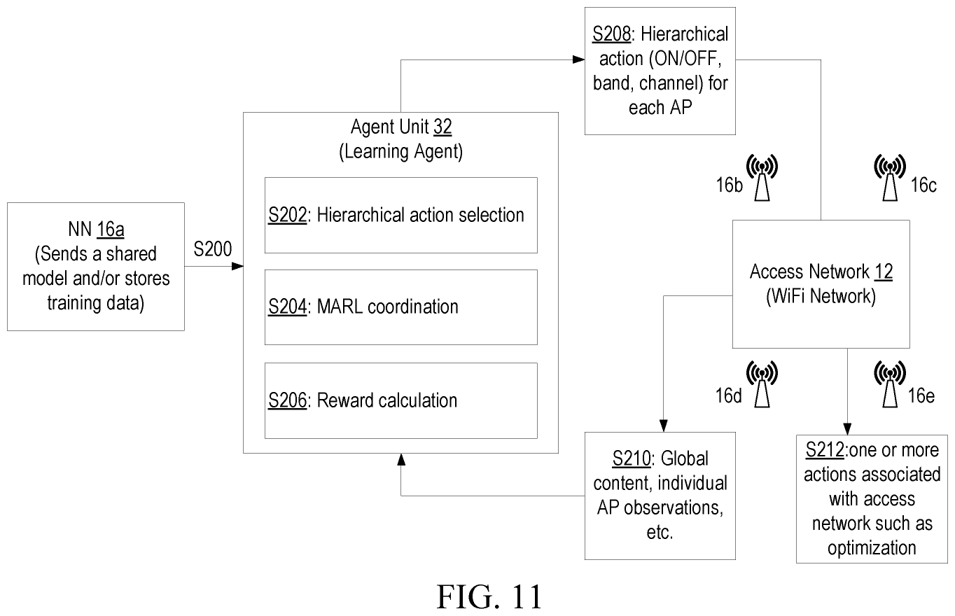

FIG. 11 shows an example a multi-agent hierarchical RL process and/or corresponding components such as agent unit 32 (e.g., learning agent) of network node 16a (e.g., a network configuration node, network optimization node, etc.). In this nonlimiting example, network node (NN) 16a may be configured to transmit a shared model and/or store training data, e.g., at step S200. Agent unit 32 (e.g., learning agent) may be configured to perform one or more of: at step S202, hierarchical action selection; at step S204, multi-agent reinforcement learning (MARL) coordination; and at step S206, reward calculation. At step S208, e.g., via agent unit 32, an action (e.g., hierarchical action may be performed for each network node 16 (e.g., network nodes 16b-16e). The action may include turning on or off one or more network nodes 16, determining a band, determining a channel, etc. One or more of network nodes 16b-16e may be associated with access network 12 (e.g., a Wi-Fi network). At step S210, agent unit 32 of network node 16a (e.g., network configuration node) may receive global content, individual AP observations, etc. At step S212, one or more actions may be performed (e.g., by any component of access network 12). The actions may comprise configuration (e.g., optimization) actions.

In some embodiments, access network 12 may be configured such as via an AP ON and OFF decision followed by band and channel allocations. In some other embodiments, modeling a problem as a multi-agent reinforcement learning problem is described. In an embodiment, networks may be configured using coordinated reinforcement learning to address a coordination challenge while considering protocol specific key performance indicators (KPI) (e.g., Wi-Fi specific KPIs). The hierarchical reinforcement learning process may be performed to handle a sequential action formulation. In another embodiment, the sequential decision can be replaced by a joint configuration (e.g., optimization) of bandwidth and channel allocations. The process may be used to dynamically train an agent optimizing the configuration of the access network 14 (e.g., Wi-Fi network). The agent may be trained in simulation, local testbed, or directly in the live network.

In some embodiments, one or multiple networks such as access networks 14 are described. The access networks 14 may be Wi-Fi networks, each comprising one or more network nodes configured as Wi-Fi APs. In some other embodiments, a network node 16 (e.g., network node 16a comprising agent unit 32 such as a learning agent) is configured to coordinate bandwidths of multiple APs in the network. In an embodiment, network node 16 (e.g., network node 16a) is configured as network configuration/optimization node and/or trains an agent model.

Agent unit 32 (e.g., learning agent) of network node 16 may be configured to transmit bandwidth and channel allocation to the different network node 16 (e.g., different APs) at a predetermined frequency such as a frequency ranging from 10 seconds to 15 minutes. The predetermined frequency may depend on one or more implementations, e.g., in order to avoid overhead in informing the WDs (e.g., the Wi-Fi stations (STAs) about the change. In some embodiment, although the learning agent sends information at a predetermined frequently to the different APs, the information in may not imply any change in deployment parameters. In some other embodiments, the frequency of the decision and data collection can be a hyperparameter of the system, such as an objective function. As the network node 16 (e.g., via agent unit 32) determines bandwidth and channel allocations or to turn off an AP, the different users in the network might be re-associated to different APs. The overhead (such as in terms of signaling, latency, or energy) of reallocation can be taken into account in the reward function of the process. In some embodiments, the decision frequency can be adapted to avoid making changes at certain time of the day.

In one or more embodiments, communication of the data from the one network node 16 (e.g., AP) to another network node 16 (e.g., a central node in the network) and vice versa may be performed to transmit a change in a parameter (e.g., bandwidth). The other network node 16 (e.g., central node) may be configured to perform the learning and inference (e.g., via agent unit 32) and be located in the network (e.g., comprised in an AP). In an embodiment, the process allows for a distributed inference, and network node 16 (e.g., the AP) may be configured to perform (e.g., via agent unit 32) inference of the neural network layers.

In some embodiments, one or more steps (e.g., steps 1-7) may be performed (e.g., by network node 16 via agent unit 32).

Step 1: Network node 16 (e.g., the network optimization/configuration node (NON)) determines which parameters such as KPIs to configure (e.g., optimize). In a nonlimiting example, the parameters may comprise a weighted combination of user throughput and resource utilization (bandwidth and power). For the throughput, fairness metrics can be used (e.g., configuring edge user throughput, or using the sum of the log of the throughputs). Tradeoffs between performance and resource utilization can be expressed using a tunable weight or through constraint or desired ranges. Another parameter that may be configured is delay. Further, various objective formulations may be supported, including constraints-based formulations (e.g., reward calculation). The decision of which objective to use may be based upon business intents or higher-level functions.

The one or more of the following steps describe a training loop of the reinforcement learning agent.

Step 2: Observations (e.g., data, information) from the network may be collected (e.g., by network node 16 and/or agent unit 32) by measuring KPIs associated to each network 16 (e.g., AP) and/or accessing information about the topology. In some embodiments, path loss between each AP may be measured (e.g., to determine whether turning an AP on, keeping an AP on, etc. may cause interference). In some other embodiments, network node 16 may be configured to represent relations between APs as a graph, each AP is a vertex and edges are determined based on available information about the APs such as position and path loss. If an accurate location of each AP in the network is available, it can also be used to find the edges of the graph. If no information is available, a fully connected graph or fully disconnected graphs may be used. In some embodiments, heuristics may be used. For example, APs with low path loss (e.g., below a predetermined path loss) may be considered as adjacent in the graph (using a threshold on the path loss for determining adjacency). If position is available, threshold on the distance could also be used. The result may be a graph G= (V, E), where V=(AP₁, . . . , APₙ) is the set of each AP involved in the optimization, and E=((APᵢ, APⱼ), . . . ) is a set of edges indicating possible interactions among APs.

The observation of the environment can be represented using node and edge features in a graph, which can be later on processed by a graph neural network or a message passing algorithm. Node features may comprise individual AP features. For each AP, statistics about the current signal strength, the number of connected WDs 22, and the current load may be determined/observed. Other relevant KPIs can be added. Further, the data can be shaped into a vector. Edge features may comprise features related to two or more adjacent APs, e.g., the path loss between the two connected APs and the geographical distance.

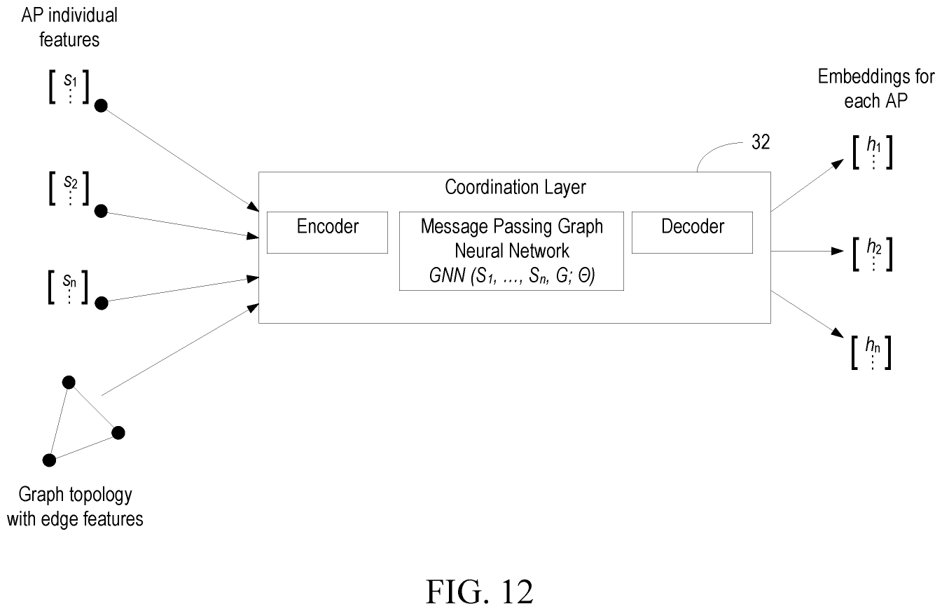

Step 3: the observed data may be fed into agent unit 32 (e.g., the learning agent) of network node 16 (e.g., as shown in FIG. 12). The first step of the learning agent may comprise a coordination layer, i.e., agent unit 32 may be configured to first perform one or more steps associated with the coordination layer. The coordination layer may be represented by graph neural networks, by fully connected networks followed by a message passing process, etc. The coordination layer may process the graph topology including edge features such as path loss. Agent unit 32 (e.g., comprising the coordination layer) may receive individual features (Sn) and/or graph topologies with edge features such as inputs. The individual features may be AP individual features. Furthermore, agent 32 (e.g., comprising the coordination layer) may be configured to perform encoder functions, determine a message passing graph neural network, perform decoder functions, and or output embeddings (e.g., for each AP) (i.e., hₙ).

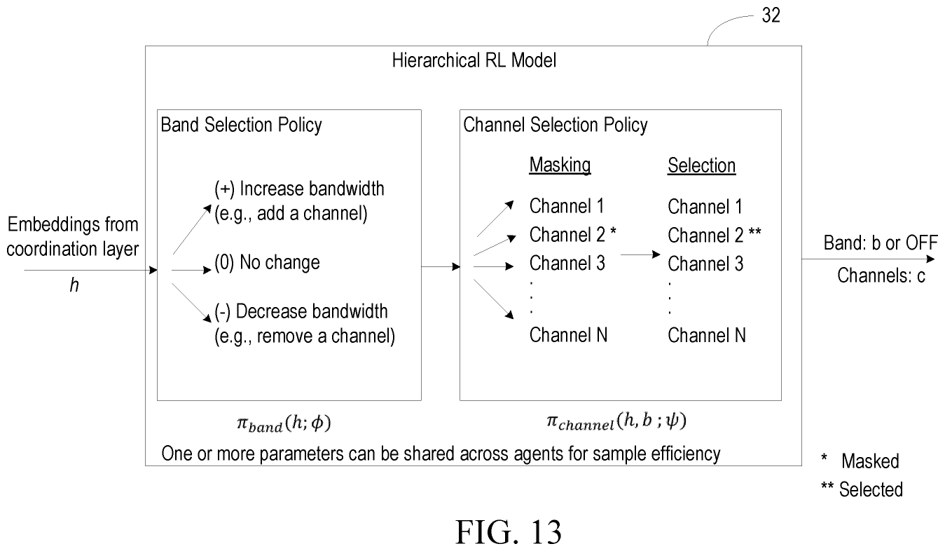

Step 4: The output of the coordination layer may be fed to the hierarchical reinforcement learning layer (HRL) (e.g., as shown in FIG. 13). The HRL layer may be the same for all agent and comprise one or more policies, e.g., one for turning on or off an AP (which may be performed at a higher level), for selecting a band, and one for selecting a channel (both are lower-level policies). Policies may be parameterized by neural networks of weights φ, ψ and/or be trained jointly. The HRL layer may output an action for each AP which is then executed in the environment.

The action space can be further specified as follows:
Action space dimension (of the band selection policy) may be one or more, e.g., ‘increase bandwidth’, ‘no change’ and ‘decrease bandwidth’. The amount of increase or decrease may depend on the bandwidth of a channel entity that is handled by channel selection policy, e.g., 20 MHz. Zero bandwidth reached by decreasing actions may result in the AP turning off. Once the action is selected, a channel selection policy may follow to select channels to add or remove to adjust the bandwidth.
Action space dimension (of the channel selection policy) is the number of available channels (or bundles of channels). For example, once a band selection policy decides to increase the bandwidth, a channel selection policy selects a channel to add to the node. Before the decision, the policy may conduct a procedure called Masking that excludes the channels already taken by the node at the current step from the set of candidate actions. For the other cases where a band selection policy decides to decrease the bandwidth, a channel selection policy may mask channels that are not taken by the node, which makes the policy select a channel to remove among the set of running channels in the node. The channel entity may be also a bundle of channels, which may be a total bandwidth of a bundle of channels such as the amount of bandwidth increase/decrease in band selection policy.

The hierarchical module (e.g., comprised by agent unit 32) may be configured to make the joint decision of bandwidth and channel tractable. However, it could be replaced by a module directly learning to make the joint decision from the embeddings. The policy would map h to a joint value (b, c).

Step 5: A reward may be collected from the environment. A scalar reward function may be defined based on the specification from network node 16 (e.g., first network node 16, the network optimization/configuration node (NON), etc.) or any other device. If the NON specifies hard constraints on the resources, then constrained-based configuration (e.g., optimization) can be used in the learning step later on. An example of reward function for the network can be given by:

$$R ( s , a ) = {w}_{1} {R}_{throughput} ( s , a ) + {w}_{2} {R}_{resources} ( s , a ) + {w}_{3} {R}_{delay} ( s , a ) + {w}_{4} {R}_{reassociation} ( s , a )$$

where wᵢ are tunable weights to achieve the desired performance. Constraint-based reward can also be supported using Lagrange techniques. The reward can take into account penalties for causing users to reassociate to other APs. The process may learn to trade-off between the gain in throughput or resource usage and this reassociation cost.

Step 6: The agent may be updated. Given a data sample (s, a, r, s′) of observation, action, reward and observation, optimization processes (such as gradient descent) may be used to update the weights of the agent by minimizing an appropriate RL loss function. Several candidates may be used such as Q-learning loss with value function factorization (e.g., reinforcement learning processes such as monotonic value function factorization and/or Value Decomposition Networks (VDN)) or by decomposing the reward function. Further, multi-agent soft actor critic loss functions may be used.

In some embodiments, shared data collection and modeling across multiple networks may be performed. For each time step, each learning agent may explore or exploit actions based on its policy model within the respective network such as Wi-Fi network, and collect a training sample consisting of KPIs, action and reward. In some other embodiments, the learning agents may transmit the training samples to the central network optimization node (e.g., network node 16 comprising agent unit 32). A universal RL policy model may be trained in the central network optimization node. Once the model is updated, the model is transferred to each learning agent for the next time step. This iterative model update may continue until the termination of training. The trained policy may be generalized to various topologies of APs in different Wi-Fi networks.

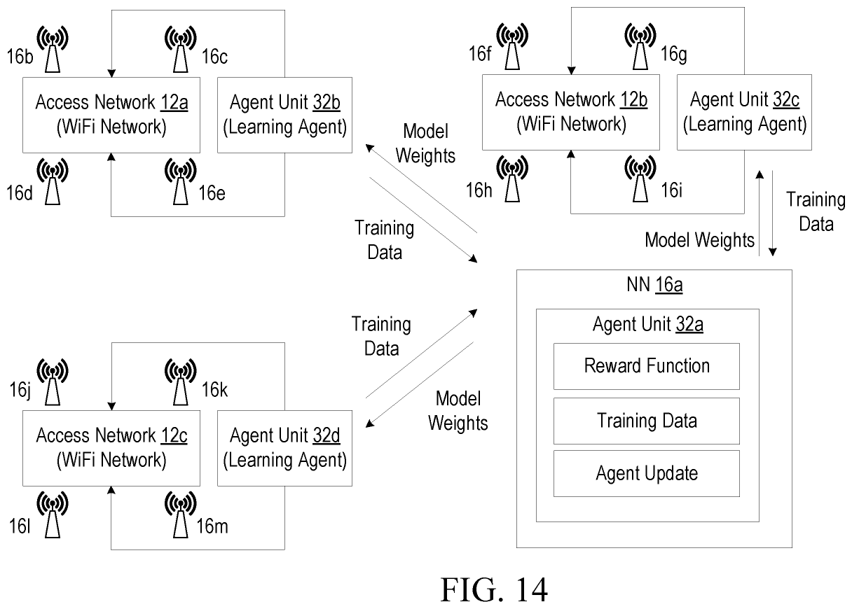

Step 7: The trained agent may be transferred to another network. FIG. 14 shows an example network node 16 (e.g., network configuration node, network optimization node) configured to train a learning agent (e.g., agent unit 32) such as in a central network node 16 (e.g., in the central server). Network node 16 may be configured to transfer a pretrained model to other networks (e.g., Wi-Fi networks) that needs to be optimized and use data from multiple networks to train a general optimization agent.

The local RL training loop can be executed in the other network while using an already trained agent. From the point of view of the network node 16a (e.g., network optimization node), each access network 14 to configure can be considered as a rollout worker with its own environment (e.g., performed in distributed RL). Distributed RL paradigms such as A3C may be used, e.g., to efficiently process the data from the different Wi-Fi networks and handle the distribution of the model efficiently. The agent unit 32 may be configured for updates to occur locally in each Wi-Fi network, where network node 16a (e.g., central node) can be configured to just collect and share the model weights.

Although Steps 1-7 are described, the steps of any of the processes of the present disclosure are not limited as such and may be performed in any order and/or include any other steps.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A first network node configured to communicate with a plurality of network nodes, each network node of the plurality of network nodes being configurable to communicate with one or more wireless devices in a network, the first network node comprising processing circuitry configured to:
determine a network configuration of one or more network nodes of the plurality of network nodes using one or both of a coordination layer and a hierarchical layer; and
cause transmission of the network configuration to the one or more network nodes to configure the one or more network nodes to communicate with the one or more wireless devices using the network configuration.

2. The first network node of claim 1, wherein the processing circuitry is further configured to:
determine one or more key performance indicators, KPIs, associated with the plurality of network nodes to determine the network configuration.

3. The first network node of claim 2, wherein the processing circuitry is further configured to:
collect data from the network by measuring the one or more KPIs and obtaining information about a network topology of the network.

4. The first network node of claim 2, wherein the collection of data from the network comprises one or both of:
measuring a path loss between each network node of the plurality of network nodes; and
determining relations between each network node based at least in part on the path loss, the determined relations being represented as a graph.

5. The first network node of claim 3, wherein the processing circuitry is further configured to:
feed the collected data into a learning agent comprising the coordination layer.

6. The first network node of claim 5, wherein the processing circuitry is further configured to:
determine one or more embeddings associated with the one or more network nodes based on the collected data that is fed to the learning agent, the collected data comprising one or both of network node individual features and a graph topology with edge features.

7. The first network node of claim 6, wherein the processing circuitry is further configured to:
determine one or both of a band parameter and a channel parameter associated with the one or more network nodes using a band selection policy and a channel selection policy of the hierarchical layer based on the one or more embeddings, the one or both of the band parameter and the channel parameter being comprised in the network configuration.

8. The first network node of claim 5, wherein the processing circuitry is further configured to one or both of:
collect a reward from the network; and
update the learning agent based on the collected reward.

9. The first network node of claim 5, wherein the processing circuitry is further configured to:
cause transfer of the learning agent to another network node in another network.

10. The first network node of claim 5, wherein one or more of:
the plurality of network nodes comprises a second network node and a third network node;
the first network node is one or both of a network configuration node and a first access point;
the second network node is a second access point;
the third network node is a third access point;
the network is configurable with communication protocol based on an Institute of Electrical and Electronics Engineers, IEEE, 802.11 standard; and
the configuration is determined using hierarchical multi-agent reinforcement learning.

11. A method in a first network node configured to communicate with a plurality of network nodes, each network node of the plurality of network nodes being configurable to communicate with one or more wireless devices in a network, the method comprising:
determining a network configuration of one or more network nodes of the plurality of network nodes using one or both of a coordination layer and a hierarchical layer; and
transmitting the network configuration to the one or more network nodes to configure the one or more network nodes to communicate with the one or more wireless devices using the network configuration.

12. The method of claim 11, wherein the method further comprises:
determining one or more key performance indicators, KPIs, associated with the plurality of network nodes to determine the network configuration.

13. The method of claim 12, wherein the method further comprises:
collecting data from the network by measuring the one or more KPIs and obtaining information about a network topology of the network.

14. The method of claim 13, wherein the collection of data from the network comprises one or both of:
measuring a path loss between each network node of the plurality of network nodes; and
determining relations between each network node based at least in part on the path loss, the determined relations being represented as a graph.

15. The method of claim 13, wherein the method further comprises:
feeding the collected data into a learning agent comprising the coordination layer.

16. The method of claim 15, wherein the method further comprises:
determining one or more embeddings associated with the one or more network nodes based on the collected data that is fed to the learning agent, the collected data comprising one or both of network node individual features and a graph topology with edge features.

17. The method of claim 16, wherein the method further comprises:
determining one or both of a band parameter and a channel parameter associated with the one or more network nodes using a band selection policy and a channel selection policy of the hierarchical layer based on the one or more embeddings, the one or both of the band parameter and the channel parameter being comprised in the network configuration.

18. The method of claim 15, wherein the method further comprises one or both of:
collecting a reward from the network; and
updating the learning agent based on the collected reward.

19. The method of claim 15, wherein the method further comprises:
transferring the learning agent to another network node in another network.

20. The method of claim 11, wherein one or more of:
the plurality of network nodes comprises a second network node and a third network node;
the first network node is one or both of a network configuration node and a first access point;
the second network node is a second access point;
the third network node is a third access point;
the network is configurable with communication protocol based on an Institute of Electrical and Electronics Engineers, IEEE, 802.11 standard; and
the configuration is determined using hierarchical multi-agent reinforcement learning.
